(19) United States
(12) Patent Application Publication
(10) Pub. No.: US 2013/0291806 A1
(43) Pub. Date: Nov. 7, 2013

(54) Pet Bib

(71) Applicant: Debra Lynn Fisher, Minneapolis, MN (US)

(72) Inventor: Debra Lynn Fisher, Minneapolis, MN (US)

(21) Appl. No.: 13/886,914

(22) Filed: May 3, 2013

Related U.S. Application Data
(60) Provisional application No. 61/643,588, filed on May 7, 2012.

(51) Int. Cl. A01K 29/00

(52) U.S. Cl. CPC A01K 29/00
USPC 119/855

(57) ABSTRACT

An example pet bib for use on a collar of a pet includes: an inward layer; an outward layer; a reinforced section coupled to one or more of the inward layer and the outward layer; a plurality of straps each having a first end and a second end, wherein each first end of the plurality of straps is coupled to one of the inward layer, the outward layer, and the reinforced section; and a connection mechanism coupled to the second end of each of the plurality of straps.

### BACKGROUND

Many pet owners take great care in grooming their pet's fur or having it professionally groomed. Maintaining the appearance and cleanliness of the pet's fur after grooming can be a challenge. This is especially true for pets that are shown competitively. Because of the way in which pets eat, drink, and salivate, it is difficult to prevent debris and liquid that may fall from a pet's mouth from landing on the pet's fur. Such debris and liquid can result in the pet's fur becoming dirty or having a less desirable appearance.

### SUMMARY

In one aspect, a pet bib for use on a collar of a pet includes: an inward layer; an outward layer; a reinforced section coupled to one or more of the inward layer and the outward layer; a plurality of straps each having a first end and a second end, wherein each first end of the plurality of straps is coupled to one of the inward layer, the outward layer, and the reinforced section; and a connection mechanism coupled to the second end of each of the plurality of straps.

### DESCRIPTION OF THE DRAWINGS

FIG. 1 shows an example pet bib.

FIG. 2 shows an example strap of varying length of the pet bib of FIG. 1.

FIG. 3 shows the pet bib of FIG. 1 mounted to a collar of a dog.

### DETAILED DESCRIPTION

Examples described herein relate to a bib that can be used on a pet. The bib provides a barrier that can be located under a pet's neck to limit debris and liquid from reaching the pet's fur such that the groomed appearance of the pet's fur can be maintained for longer periods of time. In other examples, the bib can be printed with aesthetically-pleased images and/or text to enhance an appearance of the pet.

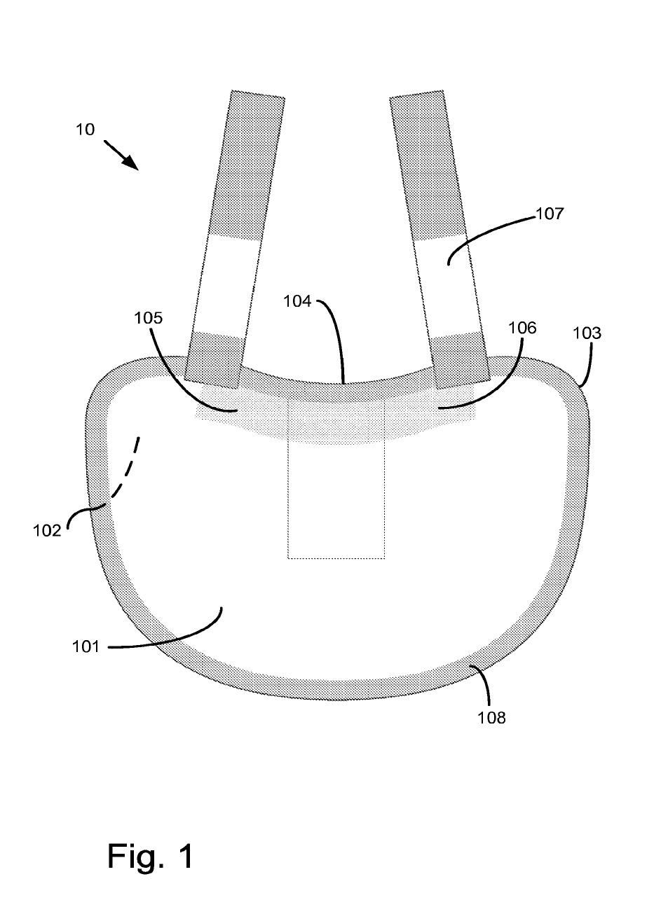

FIG. 1 illustrates the pet bib 10 while not in use. The pet bib 10 has an outward layer 101 and an inward layer 102 disposed against one another and which together form a perimeter 103. The outward layer 101 is made of a substantially fabric material, such as cotton, that can redirect solid debris and fluid that may fall from the pet's mouth and that may otherwise land on the pet's fur. The inward layer 102 is also made up of a substantially fabric material, such as flannel.

As illustrated, the outward layer 101 and inward layer 102 are formed in a substantially oblong shape that also includes a curved section 104 of the perimeter 103. The curved section 104 is oriented to substantially follow the curvature of a pet's neck 301. This is only one example configuration, and other shapes and/or sizes can be used.

In the illustrated example, a stiffening member 105 is located between the outward and inward layers 101, 102 and is oriented along the curved section 104 of the perimeter 103. The stiffening member 105 is made of a substantially rigid material, such as interfacing or plastic. The outward layer 101, the stiffening member 105, and the inward layer 102 are connected together using various techniques, such as by stitching or by an adhesive material.

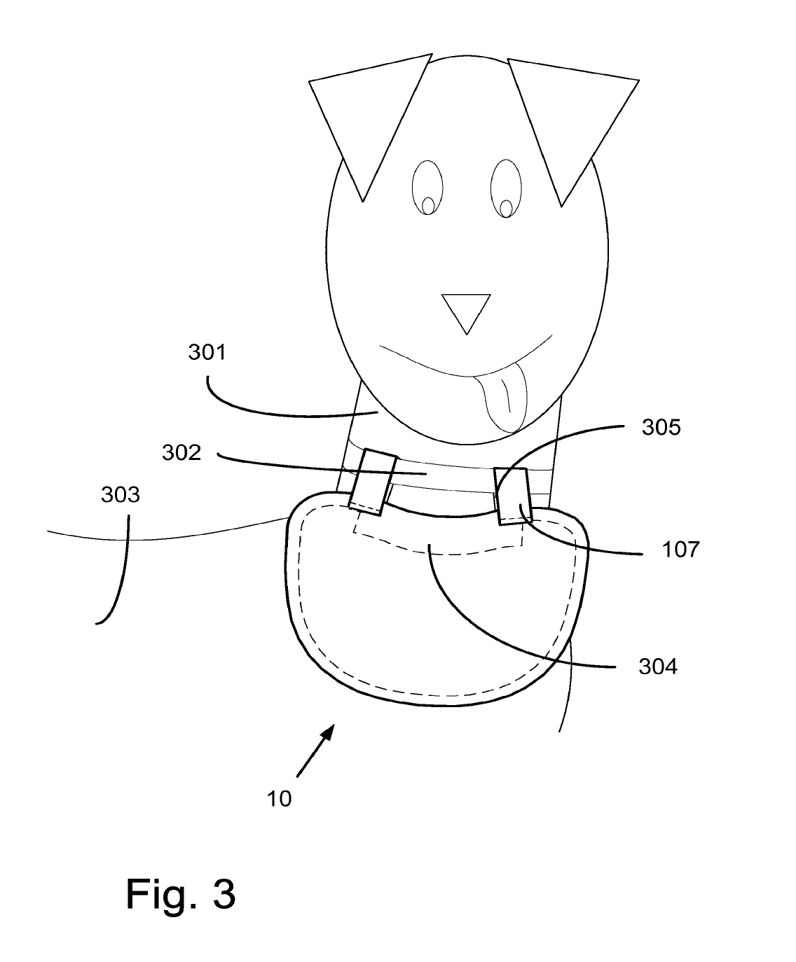

As indicated in FIG. 1, the stiffening member 105 is smaller than the outward and inward layers 101, 102, and is oriented in the area along and adjacent to the curved section 104. The location of the stiffening member 105 is designed to increase the rigidity of specific portions of the pet bib 10. When the pet bib 10 is located under a pet's neck 301, the pet bib 10 can tend to gather under the pet's neck 301 (see FIG. 3). The increased rigidity provided by the stiffening member 105 opposes the tendency of the pet bib 10 to gather while being worn by the pet 303, thereby maintaining the pet bib 10 in the desired shape.

The portion of the pet bib 10 that includes the outward layer 101, the inward layer 102, and the stiffening member 105 forms a reinforced section 106 of the pet bib 10. Alternatively, the stiffening member 105 can be larger and may be the same size and shape as the outward and inward layers 101, 102, making the reinforced section 106 the same size as the outward and inward layers 101, 102. In another alternative embodiment, the inward layer is eliminated and the reinforced section is made up of only the outward layer and the stiffening member disposed upon one another. In yet another alternative embodiment, both the inward and outward layers are eliminated and the reinforced section 106 is made up of only the stiffening member 105. Finally, the shape and position of the stiffening member 105 can be varied as needed.

Two straps 107 are attached to the reinforced section 106 by various techniques, including stitching or by an adhesive material. The straps are made of a substantially flexible material such as plastic or polyester. FIG. 1 shows the straps 107 attached to the outward layer 101 of the reinforced section 106. Alternatively, the straps 107 can be attached to the inward layer 102 of the reinforced section or attached between the outward and inward layers 101, 102 of the reinforced section 106. The straps 107 are oriented on the reinforced section 106 such that the straps 107 lie substantially perpendicular to the curved section 104. In alternative designs, more straps can be used.

A fringe 108 is disposed substantially along the perimeter 103 of the outward and inward layers 101, 102. The fringe 108 is made of a ribbon type material such as bias tape. The fringe 108 is attached by using various techniques, such as by stitching or by an adhesive material.

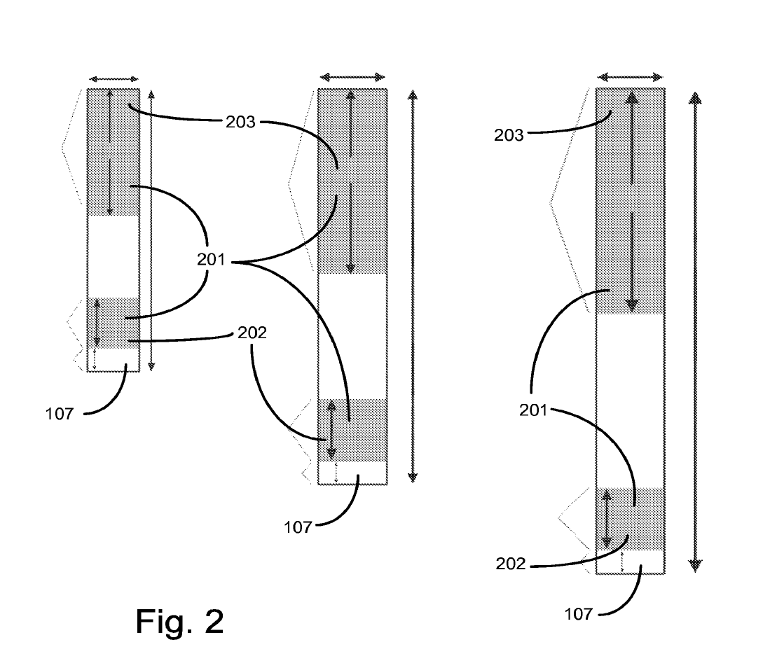

FIG. 2 shows a detail of one of the straps 107 in varying sizes. Each strap 107 includes a connection mechanism 201. The connection mechanism 201 indicated in FIG. 1 is Velcro. Alternative connection mechanisms may also be implemented such as snaps, buttons, ties, magnets, or other fasteners. The connection mechanism 201 is oriented such that when the strap 107 is looped around a pet's collar 302 and the connection mechanism 201 is fastened, the strap 107 of the pet bib 10 is substantially secured to the pet's collar 302. As shown, the connection mechanism 201 has a first part 202 and a second part 203.

The figure shows the first and second parts 202, 203 of the connection mechanism 201 located on the strap. Alternatively, the first part 202 of the connection mechanism 201 can be located on the strap and the second part 203 of the connection mechanism 201 can be located on the reinforced section 106. As indicated in FIG. 2, the strap 107 may be manufactured in varying sizes. Different sized versions of the pet bib 10 can be manufactured with varying strap 107 sizes depending on the size of the pet 303 and the thickness of the pet's collar 302 (see FIG. 3).

In another example, the pet bib 10 can include extensions that allow the straps 107 to be increased in length as needed. For example, strap extensions that include the same connection mechanism 201 used in the strap 107 connect to the straps and allow the straps to be looped around a collar that is thicker than what the strap 107 alone can accommodate. In addition, the strap extensions may be implemented to allow the straps to be placed around the pet's neck rather than the pet's collar.

FIG. 3 shows the pet bib 10 in use on a pet 303. Examples of the pet 303 include a dog, a cat, and other types of domesticated animals.

The straps 107 are looped around the pet's collar 302, and the connection mechanism 201 is fastened such that a loop 305 is formed around the pet's collar 302 and the curved section 104 is held substantially adjacent to the pet's collar 302. While the pet bib 10 is on the pet 303, the reinforced section 106 keeps the straps 107 substantially in place on the pet's collar 302 and minimizes a tendency for the pet bib 10 to buckle in the area 304 between the straps 107.

While the pet bib 10 has been described with references to a particular embodiment thereof, those skilled in the art will be able to make various modifications to the described embodiment without departing from the true spirit and scope thereof. It is intended that all combinations of elements and steps which perform substantially the same function in substantially the same way to achieve substantially the same result are within the scope of this invention.

What is claimed is:

1. A pet bib for use on a collar of a pet, the pet bib comprising:
an inward layer;
an outward layer;
a reinforced section coupled to one or more of the inward layer and the outward layer;
a plurality of straps each having a first end and a second end, wherein each first end of the plurality of straps is coupled to one of the inward layer, the outward layer, and the reinforced section; and
a connection mechanism coupled to the second end of each of the plurality of straps.

2. The pet bib of claim 1, wherein the reinforced section comprises a stiffening member disposed between the outward layer and the inward layer.

3. The pet bib of claim 2, wherein the inward layer and the outward layer extend beyond the reinforced section.

4. The pet bib of claim 1, wherein the connection mechanism comprises a first part and a second part, wherein the first part of the connection mechanism is coupled to the reinforced section, and wherein the second part of the connection mechanism is coupled to the second end of each of the plurality of straps.
